(19) United States
(12) Patent Application Publication
(10) Pub. No.: US 2010/0260925 A1
(43) Pub. Date: Oct. 14, 2010

(54) Methods and compositions for amplification of terrestrial albedo

(76) Inventor: John Frederick Brady, Menlo Park, CA (US)

Correspondence Address: FOOTHILL LAW GROUP, 777 N. FIRST STREET, SUITE 325, SAN JOSE, CA, 95112, US

(21) Appl. No.: 12/589,154

(22) Filed: Oct. 19, 2009

Related U.S. Application Data
(60) Provisional application No. 61/196,442, filed on Oct. 18, 2008.

(51) Int. Cl. B05D 5/06

(52) U.S. Cl. 427/4; 427/136

(57) ABSTRACT

In some embodiments, global climate change is mitigated by increasing Earth's surface albedo. In some embodiments, a naturally occurring, reflective crystalline material can applied over vast surface areas to provide a durable reflective layer of such material, thereby amplifying the Earth's albedo.

### CROSS REFERENCE TO RELATED CO-PENDING APPLICATIONS

This application is a regular U.S. patent application under 35 U.S.C. §111(a) and 35 U.S.C. §1.53(b) and claims priority from the following co-pending provisional application filed under 35 U.S.C. §111(b): 61/196,442 filed Oct. 18, 2008.

### BACKGROUND

Global warming is caused by human activity, and will likely continue for centuries (Intergovernmental Panel on Climate Change). Melting of reflective polar ice cover is accelerating global warming. Greenhouse gas restrictions will take decades to implement and may not achieve universal compliance. We're “toast” without action on global warming (NASA's James Hansen). Interim measures are urgently needed to minimize the immediate damage.

### DESCRIPTION

The present disclosure addresses the urgent problem of global warming, and provides a feasible interim measure to mitigate climate change. Uncontrolled climate change due to global warming will continue to damage human and non-human habitats.

Before describing the present disclosure in detail, it is to be understood that this disclosure is not limited to specific compositions, method steps, as such can vary. It is also to be understood that the terminology used herein is for the purpose of describing particular embodiments only, and is not intended to be limiting. Methods recited herein can be carried out in any order of the recited events that is logically possible, as well as the recited order of events. Where a range of values is provided, it is understood that each intervening value, between the upper and lower limit of that range, and any other stated or intervening value in that stated range, is encompassed within the description. The upper and lower limits of these smaller ranges may independently be included in the smaller ranges, and are also encompassed, subject to any specifically excluded limit in the stated range. Where the stated range includes one or both of the limits, ranges excluding either or both of those included limits are also included in the present disclosure. Also, it is contemplated that any optional feature of the disclosed variations described can be set forth and claimed independently, or in combination with any one or more of the features described herein.

All literature and similar materials cited in this application, including but not limited to patents, patent applications, articles, books, treatises, and internet web pages, regardless of the format of such literature and similar materials, are expressly incorporated by reference in their entirety for any purpose. In the event that one or more of the incorporated literature and similar materials differs from or contradicts this application, including but not limited to defined terms, term usage, described techniques, or the like, this application controls.

The publications discussed herein are provided solely for their disclosure prior to the filing date of the present application. Nothing herein is to be construed as an admission that the present disclosure is not entitled to antedate such publication by virtue of prior invention. Further, the dates of publication provided may be different from the actual publication dates, which may need to be independently confirmed.

The practice of the present disclosure will employ, unless otherwise indicated, conventional techniques which are within the skill of the art. Such techniques are explained fully in the literature.

Unless specifically defined herein, all terms used herein have the same meaning as they would to one skilled in the art of the present disclosure. Various methods, devices and materials similar or equivalent to those described herein can be used in the practice or testing of the disclosed methods.

It must be noted that, as used in the specification and the appended claims, the singular forms “a,” “an” and “the” include plural referents unless the context clearly dictates otherwise. Thus, for example, reference to “a solid support” includes a plurality of solid supports. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

Current ice cap loss is decreasing the Earth's albedo, thereby accelerating global warming. In some embodiments of the present disclosure, a naturally occurring, reflective crystalline material can applied by any suitable method, to provide a durable reflective layer of such material. In some embodiments, a naturally occurring, reflective crystalline material can applied to surface areas, providing a durable reflective coating or film over a vast areas, thereby amplifying the terrestrial albedo. In some embodiments of the present disclosure, a naturally occurring, reflective crystalline material can applied in a water-based spray, providing a durable reflective coating or film over a vast area.

In some embodiments, in the present disclosure, cessation and/or reversal of global warming is achieved by applying a reflective crystalline material, including common light colored minerals, to extensive areas which can include areas comprising plants, soil, rock, pavement, structures, and roofs. Examples of plants and plant structures include fruits, vegetables, trees, flowers, leaves, grasses, roots, seeds and landscape and ornamental plants. A non-limiting example of such a mineral is kaolin clay.

In some embodiments, amplification of terrestrial albedo is achieved by applying a reflective crystalline material, including common light colored minerals, to extensive areas, which can include areas such as plants, soil, rock, pavement, structures, and roofs. A non-limiting example of a suitable light colored mineral is kaolin clay, although other materials may be used as described herein.

The acreage, locations, and quantities of a suitable reflective crystalline material can be determined by calculation and by empirical observation. The surface area to be covered can be hundreds, thousands, millions or billions of acres.

Any conventional method may be used herein to measure global temperature. Despite the enormous variation in climate and regional temperature around the world, scientists use an average temperature for the entire surface of the Earth to measure for atmospheric changes as a whole. Although local temperatures may grow either warmer or cooler from year to year, the overall average temperature of the Earth has been rising over the past century.

In some embodiments, when the average temperature of the Earth is measured, readings from the coldest and hottest places are measured before calculating an average temperature.

In some embodiments, the methods herein can be used to prevent a sustained rise in overall average Earth temperature over the course of time. The methods can be used, for example to prevent a sustained rise of 0.1° C., 0.5° C., 1° C., 2° C., 5° C., 10° C. or more. Using embodiments of the present methods, the sustained rise in overall average Earth temperature can be prevented over any time desired period. Examples of such a period include 6 months, 1 year, 2 year, 5 years, 10 years, 20 years, 50 years, 100 years or more.

In some embodiments, application of one or more reflective crystalline materials, as described herein, provides a method for adjusting the average overall temperature of the Earth to any desired temperature. In some embodiments, application of one or more reflective crystalline materials, as described herein, results in a detectable decrease in average overall global temperature within about 6 months or less, within about one year or less, within about 2 years or less, within about 5 years or less, or within about 10 years or less. The decrease in average global temperature can be adjusted by the area covered by the application and/or by the nature of the crystalline material. For example, the decrease in global temperate in one year can be 0.1° C., 0.5° C., 1° C., 5° C., 10° C. or more.

In some embodiments, application of one or more reflective crystalline materials, as described herein, provides a detectable decrease in overall global average atmospheric temperature within about one year or less. The decrease can be adjusted by the area covered by the application and by the nature of the crystalline material. For example, the decrease in average overall global atmospheric temperate in one year can be 0.1° C., 0.5° C., 1° C., 5° C. or more.

Application of a reflective crystalline material, as described herein, provides a detectable decrease in global average water temperature within about one year or less. For example, the decrease in global average water temperate in one year can be 0.1° C., 0.5° C., 1° C., 2° C., 5° C. or more.

Application of a reflective crystalline material, as described herein, provides a detectable increase (i.e. amplification) in Earth surface albedo. The albedo of an object is the extent to which it diffusely reflects light from light sources such as the Sun. In some embodiments, the present disclosure provides methods of amplifying terrestrial albedo. The increase in surface albedo can be adjusted by the area covered, and by the nature of the crystalline material used, with brighter or lighter materials having a greater effect. For example, in some embodiments, the increase can be 0.1%, 0.5%, 1%, 5%, 10%, 20%, 30%, 40%, 50%, 70%, 100% or more. The increase can be in the range of about 1-fold to about 5-fold, for example. The increase can be in the range of about 1-fold to about 100-fold, for example.

The Earth's surface albedo can be measured using any conventional method. For example, the Earth's surface albedo can be estimated via satellite sensors. Non-limiting examples of such sensors include Earth observation satellite sensors such as NASA's MODIS instruments onboard the Terra and Aqua satellites.

The reflective materials as described herein can be applied at any suitable geographical location. In some embodiments, the locations are those that receive sunlight. Non-limiting examples of such locations include northern hemispheric regions, southern hemispheric regions, equatorial regions, desert regions, forest regions, and tropical regions. The locations can include skyward facing surfaces, and can include farms, cities, forests, roads, pavement, parks, school grounds, gardens, lawns, and roofs. The areas covered can be contiguous or non-contiguous. In some embodiments, the locations exclude areas covered by permafrost.

Non-limiting examples of suitable reflective microcrystalline materials for use in the present methods include, finely divided hydrophobic particulate solids including minerals, such as kaolin, calcium carbonate, mica, talc, bentonites, clays attapulgite, pyrophyllite, wollastonite, silica, feldspar, sand, quartz, chalk, limestone, precipitated calcium carbonate, diatomaceous Earth and barytes. Other examples include thixotropic clay materials, lipophilic hixotropic clay, smectic clay, organo-clay (see, e.g., U.S. Pat. No. 6,857,224). Non-limiting examples of commercially available products include PFT-X, Surround®, Pyramite®, Orchex 796, L6F, and Slygard 309. The material can be combined with a stabilizer and/or emulsifier.

In some embodiments, when applied to plants, the coating can be made water resistant by mixing with various materials; for example, wax emulsions (see, e.g., U.S. Pat. Nos. 6,857,224 and 5,908,708). When applied to some surfaces, such as rock, pavement, and rooftops, conventional paint base may be used. A loss of the coating over time, such as through weathering, may advantageously provide a method for controlling or modulating the amplification of surface albedo. The reflective material may be re-applied as needed.

In some embodiments, materials such as those described in U.S. Pat. No. 3,775,147 may be used in the present methods. These include reflective microcrystalline materials such as siliceous kaolinite clay, titanium dioxide, talc, gypsum, limestone, etc. Other materials can include Bethel white granite, Georgia granite or other similar materials. In some embodiments, the reflective materials are spread over the surface of extensive land areas. In some embodiments, a light-colored mulch, such as a white mulch comprising one or more reflective microcrystalline materials as described herein can be used in order to amplify terrestrial surface albedo. In some embodiments, a light-colored gravel sized particle comprising one or more reflective microcrystalline materials as described herein can be used in order to amplify terrestrial surface albedo, where gravel particles are typically intermediate in size between sand grains and boulders

In some embodiments, finely divided, reflective microcrystalline materials such as described in U.S. Pat. No. 6,027,740 may be used. These include calcined kaolins, hydrophobic calcined kaolins, hydrophobic calcium carbonates, calcium carbonates and mixtures thereof.

In some embodiments, a microcrystalline material for use in the present methods does not interfere with photosynthesis. In some embodiments, a microcrystalline material for use in the present methods enhances photosynthesis (see, e.g., U.S. Pat. No. 6,110,867).

In some embodiments, a suitable microcrystalline reflective material comprises a particulate material as described in U.S. Pat. No. 6,069,112 comprising a heat treated particulate material heated to a temperature from about 300° C. to about 1,200° C. In some embodiments, the particulate material as applied to a plant permits an exchange of gases on the surface of plant and the particulate material film has a thickness from about 1 μm to about 1,000 μm. In some embodiments, the material can be applied to at least a portion of the plant surface by spraying. The particulate materials can by hydrophobic. In some embodiments, the particulate materials do not comprise calcium hydroxide. In some embodiments, the particulate material has a particle size distribution wherein most of the particles have a particle size of under about 10 microns. In some embodiments, the particulate material comprises a hydrophilic core and a hydrophobic outer surface. In some embodiments, the core material comprises one or more of calcium carbonate, mica, hydrous kaolin, bentonite, clays, pyrophyllite, silica, feldspar, sand, quartz, chalk, limestone, diatomaceous Earth, baryte, aluminum trihydrate, and titanium dioxide. In some embodiments, the core material comprises one or more of calcined calcium carbonate, calcined talc, calcined kaolin, calcined bentonites, calcined clays, calcined pyrophyllite, calcined silica, calcined feldspar, calcined sand, calcined quartz, calcined chalk, calcined limestone, calcined precipitated calcium carbonate, calcined diatomaceous Earth, calcined barytes, calcined aluminum trihydrate, calcined pyrogenic silica, and calcined titanium dioxide. In some embodiments, the hydrophobic outer surface comprises one or more of organic titanates, organic zirconate or aluminate coupling agents, organofunctional silanes, modified silicone fluids and fatty acids and salts thereof.

In some embodiments, a plant to be coated with a material described herein can be selected from actively growing or fruiting agricultural and ornamental crops. In some embodiments, a plant need not be actively growing. A plant can be selected from the group consisting of fruits, vegetables, trees, flowers, grasses, roots, seeds and landscape and ornamental plants. A reflective crystalline material as described herein can be applied to essentially any suitable surface of a plant. Non-limiting examples of such surfaces include leaves, branches and bark. In some embodiments, the material is applied primarily to a skyward-facing surface of a plant.

In some embodiments, a suitable reflective material comprises a particulate material as described in U.S. Pat. No. 6,110,867 comprising one or more highly reflective particulate materials, said particulate materials being finely divided. In some embodiments, the particulate particles as applied to a plant allow for the exchange of gases on the surface of said plant. In some embodiments, the finely divided particulate materials have a median individual particle size below about 3 microns. In some embodiments, the particulate material has a Block Brightness of at least about 90. In some embodiments, the particulate materials are hydrophobic. In some embodiments, the particulate materials are hydrophilic. In some embodiments, the particulate materials have a particle size distribution wherein most of the particles have a particle size of under about 10 microns.

1. A method comprising the steps of:
preventing a sustained rise of more than 1° C. in overall average Earth temperature by applying to surfaces of the Earth one or more highly reflective particulate materials.

2. The method of claim 1 wherein said applying comprises applying said materials to skyward facing plant surfaces.

3. The method of claim 2 wherein said materials comprise kaolin clay.

4. The method of claim 1 wherein said method prevents a sustained rise in overall average Earth temperature over a period of 10 years.

5. The method of claim 1 wherein said applying comprises incorporating a light-colored mulch into soil, the light-colored mulch comprising one or more highly reflective particulate materials.

6. The method of claim 2 wherein said materials are applied as a water-resistant coating.

7. A method comprising the steps of:
detectably amplifying Earth's surface albedo by applying to surfaces of the Earth one or more highly reflective particulate materials.

8. The method of claim 7 comprising measuring Earth's surface albedo before and after said applying.

9. The method of claim 7 wherein said surfaces comprise farmland.

10. The method of claim 7 wherein the surface albedo is enhanced by at least 30%.

11. The method of claim 7 wherein said method comprises applying said materials to skyward facing plant surfaces.

12. The method of claim 11 wherein said plant surfaces comprise leaves.

13. The method of claim 7 where said surfaces comprise soil.

14. A method comprising the steps of:
applying to surfaces of the Earth one or more highly reflective particulate materials in an amount which is effective to detectably lower average global atmospheric temperature.

15. The method of claim 14 wherein the average global atmospheric temperature is lowered by at least 1° C. within one year.

16. The method of claim 14 wherein said applying comprises applying said materials to skyward facing plant surfaces and wherein said materials essentially do not interfere with photosynthesis.

17. The method of claim 14 wherein said materials comprise calcium carbonate.

18. The method of claim 14 wherein said method comprises applying said materials to soil.

19. The method of claim 18 wherein said applying comprises incorporating a light-colored mulch into soil, the light-colored mulch comprising one or more highly reflective particulate materials.

20. The method of claim 18 wherein said surfaces comprise forest regions.
